(19) United States
(12) Patent Application Publication
(10) Pub. No.: US 2014/0149525 A1
(43) Pub. Date: May 29, 2014

(54) METHOD AND APPARATUS FOR TRANSMITTING AND RECEIVING INSTANT MESSAGE

(71) Applicant: Electronics and Telecommunications Research Institute, Daejeon (KR)

(72) Inventors: Hwanjo HEO, Daejeon (KR); Nam Seok KO, Daejeon (KR); Jong Dae PARK, Daejeon (KR); Woo-Sug JUNG, Daejeon (KR); Sung Jin MOON, Daejeon (KR); Sung Kee NOH, Daejeon (KR); Byung Ho YAE, Daejeon (KR); Tae-Soo CHUNG, Daejeon (KR)

(73) Assignee: Electronics and Telecommunications Research Institute, Daejeon (KR)

(21) Appl. No.: 14/092,799

(22) Filed: Nov. 27, 2013

(30) Foreign Application Priority Data
Nov. 28, 2012 (KR) 10-2012-0136539

(51) Int. Cl. H04L 12/58

(52) U.S. Cl. CPC H04L 51/04
USPC 709/206

(57) ABSTRACT

In a case where a transmitting apparatus transmits an instant message, for the generated message, an alert command mode in which it is instructed to perform alert processing when a receiving apparatus receives the message or a no alert command mode in which it is instructed not to perform the alert processing when the receiving apparatus receives the message are set up. Then, the receiving apparatus performs the alert processing when the alert command mode is set up for the received message and does not perform the alert processing when the no alert command mode is set up for the received message.

### CROSS-REFERENCE TO RELATED APPLICATION

This application claims priority to and the benefit of Korean Patent Application No. 10-2012-0136539 filed in the Korean Intellectual Property Office on Nov. 28, 2012, the entire contents of which are incorporated herein by reference.

### BACKGROUND OF THE INVENTION

(a) Field of the Invention

The present invention relates to a method and an apparatus for transmitting and receiving an instant message.

(b) Description of the Related Art

Recently, due to the proliferation of mobile devices such as smart phones, instant messaging (IM) has become more popular than traditional ways of communication such as telephoning, short message service (SMS), and e-mail.

An instant message is an electronic form of message in a combination of texts, images, audios, and videos being sent and received between at least two apparatuses using one or more networking systems such as the Internet and mobile networks.

When an instant message arrives at one or a plurality of receivers, a notification, informing th e user of a message arrival according to the alert configuration that has previously been set up at the receiving device or the IM application, is performed. The notification can be made by an audible bell output, a vibration, a pop-up message, or an entry insertion in the notification area.

Current instant messaging services, however, lack a feature which lets the message sender to differentiate the notification method depending on the message receiver's situation that is inferred by the message sender; it is the message receiver's sole responsibility—in the sense that the message sender does not have any control over it—to properly set the notification method for her/his own sake. For example, when sleeping, the receiver must set up the alert method in which a bell or a vibration is not generated with a set-up function of his or her smart phone or instant message application, to ensure that the receiver will not be disturbed. When the receiver does not take such a measure, he or she will be disturbed by the bell or vibration when receiving a message. The message sender may not want to disturb the message receiver's sleep with the audible bell because her/his message is not urgent; however, she or he does not have any control over the notification method on the recipient device. The situation where the message sender may have such intention, not disturbing the message receipient, can be also determined by other factors such as the priority of message content or delivery urgency.

Therefore, a method for controling the notification method set up by the message sender in the instant message service in accordance with the implied state of the receiver or the urgency of the message is required.

### SUMMARY OF THE INVENTION

A technical object of the present invention is to provide a method and an apparatus for a transmitter to determine whether a receiving message alert operation of a receiver is performed when an instant message is transmitted.

A method of a transmitting apparatus transmitting an instant message according to an exemplary embodiment of the present invention includes generating a message, for the message, setting up an alert command mode in which it is instructed to perform alert processing when a receiving apparatus receives the message or a no alert command mode in which it is instructed not to perform the alert processing when the receiving apparatus receives the message, and transmitting the message for which the alert command mode or the no alert command mode is set up.

Setting up the alert command mode or the no alert command mode may include setting up the no alert command mode for the message when a previously set up character stream is included in the generated message. In setting up the alert command mode or the no alert command mode, the alert command mode or the no alert command mode is set up in accordance with an operation of a toggle button provided in the transmitting apparatus.

The method may further include additionally setting up a receiving alert allow time that represents that the alert processing is performed after a set up time from a time when the receiving apparatus receives the message when the no alert command mode is set up for the message.

The alert processing may represent that receiving of the message is acoustically informed in a form of a bell or a vibration.

A message transmitting apparatus may include a message generator for generating a message, a receiver processing set-up unit for setting up an alert command mode in which it is instructed to perform alert processing when a receiving apparatus receives a message or a no alert command mode in which it is instructed not to perform the alert processing when the receiving apparatus receives the message for the message, and a message transmitting unit for transmitting the message for which the alert command mode or the no alert command mode is set up.

The receiver processing set-up unit may set up a no alert command mode for the message when a previously set up character stream is included in the generated message.

The message transmitting apparatus may further include a state information managing unit for receiving state information that represents a network access state of a receiving apparatus from a server of a network to manage the received state information for an instant message service. The message transmitting unit may transmit the message to the receiving apparatus that accesses the network based on the state information.

A method of a receiving apparatus receiving an instant message may include receiving a message, determining whether an alert command mode or a no alert command mode set up by a transmitting apparatus is set up for the received message, performing alert processing that informs that the message is received when the alert command mode is set up for the received message, and not performing the alert processing that informs that the message is received when the no alert command mode is set up for the received message.

In not performing the alert processing, when the no alert command mode is set up for the received message, although an operation mode of the receiving apparatus is set up as a receiving alert mode, the alert processing may not be performed.

The method may further include, after not performing the alert processing, in a case where the no alert command mode is set up for the message and a receiving alert allow time is additionally set up for the message, when the receiving alert allow time passes from a time when the message is received, performing the alert processing.

Performing the alert processing may include determining whether a receiving no alert mode is set up by the receiving apparatus, when the receiving no alert mode is set up, not performing the alert processing regardless of an alert command mode set up for the received message, and, when the received no alert mode is not set up, performing the alert processing in the alert command mode set up for the received message.

A message receiving apparatus may include a message receiving unit for receiving a message, a transmitter command reading unit for determining whether an alert command mode or a no alert command mode set up by a transmitting apparatus is set up for a received message, and a receiving alert unit for performing alert processing that informs that the message is received when the alert command mode is set up for the received message and not performing the alert processing that informs that the message is received when the no alert command mode is set up for the received message.

When the no alert command mode is set up for the message and a receiving alert allow time is additionally set up for the message, the receiving alert unit may perform the alert processing when the receiving alert allow time passes from a time when the message is received.

### BRIEF DESCRIPTION OF THE DRAWINGS

FIG. 1 is a view illustrating a structure of an instant message transmitting apparatus according to an exemplary embodiment of the present invention.

FIG. 2 is a flowchart of an instant message transmitting method according to an exemplary embodiment of the present invention.

FIG. 3 is a view illustrating a structure of an instant message receiving apparatus according to an exemplary embodiment of the present invention.

FIG. 4 is a flowchart of an instant message receiving method according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the entire specification, unless explicitly described to the contrary, the word “comprise” and variations such as “comprises” or “comprising” will be understood to imply the inclusion of stated elements but not the exclusion of any other elements.

Hereinafter, a method and an apparatus for transmitting and receiving an instant message according to an exemplary embodiment of the present invention will be described with reference to the drawings.

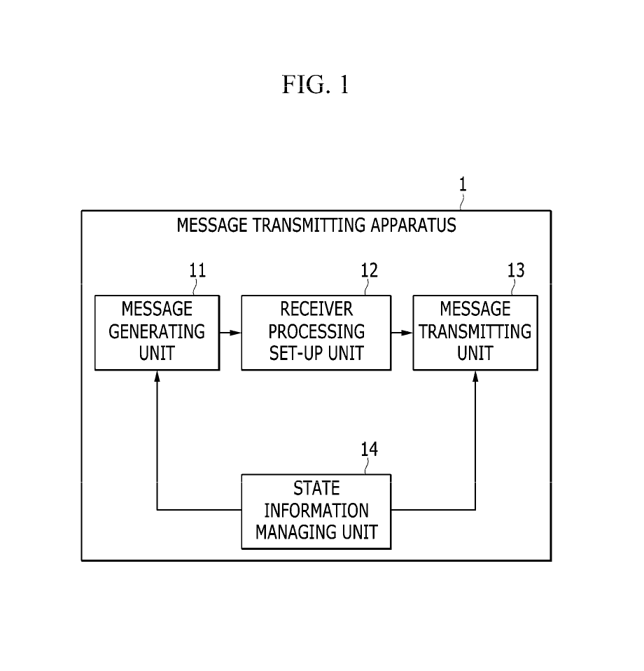

FIG. 1 is a view illustrating a structure of an instant message transmitting apparatus according to an exemplary embodiment of the present invention.

As illustrated in FIG. 1, an instant message transmitting apparatus 1 according to an exemplary embodiment of the present invention may further include a message generator 11, a receiver processing set-up unit 12, and a message transmitting unit 13, and may further include a state information managing unit 14.

The message generator 11 generates a message to be transmitted.

The receiver processing set-up unit 12 sets up a control command in accordance with processing to be performed by a receiver on the message to be transmitted. According to an exemplary embodiment of the present invention, an alert command mode and a no alert command mode are set up for the transmitted message, and the alert command mode and the no alert command mode are control command modes in which the receiver instructs to process the corresponding message. In the alert command mode, when the receiver receives the corresponding message, it is instructed to perform alert processing that may disturb the receiver such as with a bell or a vibration. In the no alert command mode, when the receiver receives the corresponding message, it is instructed not to perform alert processing that may disturb the receiver. Here, the alert processing that may disturb the receiver (e.g., sleeping or a conference) is a bell output or a vibration that stimulates a sense of hearing of the receiver so that the receiver may recognize that the message is received. However, the alert processing is not limited to the above but may include visual alert processing.

When previously set up character streams such as “#”, “no alert”, and “alert” are included in a generated message, the receiver processing set-up unit 12 may set up the no alert command mode or the alert command mode for the corresponding message.

The receiver processing set-up unit 12 may include a toggle button so that a user may easily set up the alert command mode and the no alert command mode for the message. In this case, the alert command mode or the no alert command mode may be set up in accordance with an operation of the toggle button.

The receiver processing setting unit 12 may fixedly provide the alert command mode to a transmitted message, and may change the alert command mode of the message into the no alert command mode when a specific key is input after the message is generated.

On the other hand, when the no alert command mode is set up, the receiver processing set-up unit 12 may additionally set up time to allow the alert processing that may disturb the receiver to be performed (receiving alert allow time). For example, the receiving alert allow time that represents that a receiving apparatus performs alert processing after the set up time from the time when the receiving apparatus receives a message may be additionally set up.

The message transmitting unit 13 transmits the generated message to the receiving apparatus. Particularly, the message for which the alert command mode or the no alert command mode is set up by the receiver processing set-up unit 12 is transmitted to the receiving apparatus.

On the other hand, the state information managing unit 14 obtains and manages state information on the receiver required for the instant message service. For example, the state information managing unit 14 receives presence information including access states of service users from a server (not shown) on a network to manage the received presence information. The message transmitting unit 13 may transmit the message to an apparatus confirmed to access the network based on the presence information.

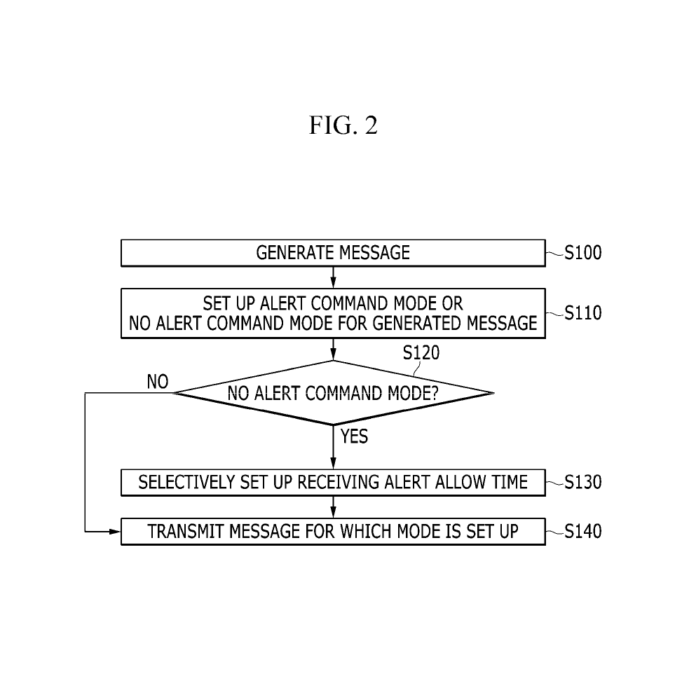

FIG. 2 is a flowchart of a message transmitting method according to an exemplary embodiment of the present invention.

As illustrated in FIG. 2, the transmitting apparatus 1 generates a message to be transmitted (S100). Here, the transmitting apparatus 1 receives state information on receiving apparatuses from a server (not shown) on a network, and may set up a receiving apparatus that accesses the network to receive a service in accordance with the state information.

The transmitting apparatus 1 sets up an alert command mode or a no alert command mode for the message to be transmitted (S110). When a previously set up specific character stream is included in the generated message or the no alert command mode is selected by a toggle button, the no alert command mode is set up for the message. When the previously set up specific character stream is not included in the message or the alert command mode is selected by the toggle button, the alert command mode is set up for the message. As described above, the transmitting apparatus 1 sets up a mode corresponding to processing to be performed by a receiver while receiving the message for the message generated by an intention of a user.

When the no alert command mode is set up, the transmitting apparatus 1 additionally sets up a receiving alert allow time that represents that the receiving apparatus performs alert processing after the set up time from the time when the message is received (S120 and S130). The above may be selectively performed.

Then, the transmitting apparatus 1 transmits the message for which the no alert command mode or the alert command mode is set up to the receiving apparatus. The transmitted message may be formed to include a code corresponding to the set up mode (S140).

Through the above processes, the user may easily set up whether a received message alert operation of the receiver is performed when the message is transmitted. Therefore, when a message with no emergency is transmitted, since a transmitter may set up the no alert command mode for the message to transmit the message, the transmitter may send the message without disturbing sleep or work of a receiver.

Next, an apparatus and a method for receiving an instant message according to an exemplary embodiment of the present invention will be described.

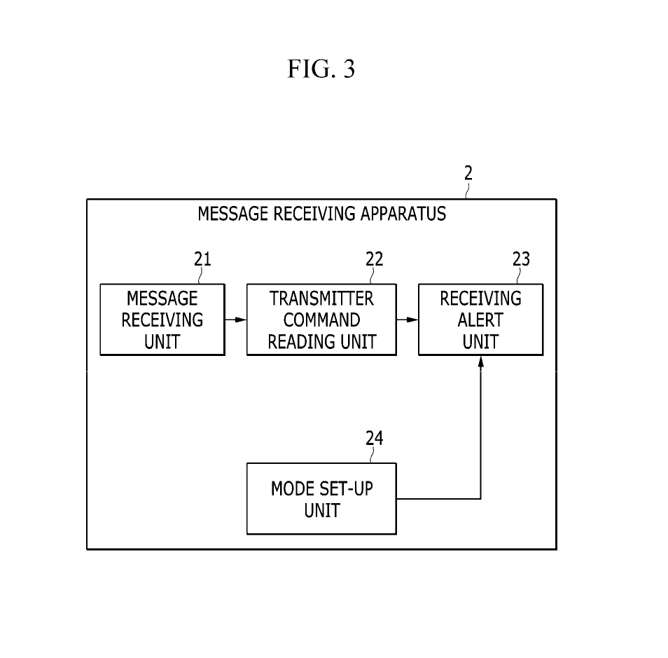

FIG. 3 is a view illustrating a structure of an instant message receiving apparatus according to an exemplary embodiment of the present invention.

As illustrated in FIG. 3, an instant message receiving apparatus 2 according to the exemplary embodiment of the present invention includes a message receiving unit 21, a transmitter command reading unit 22, and a receiving alert unit 23, and may further include a mode set-up unit 24.

The message receiving unit 21 receives a message transmitted from the transmitting apparatus 1.

The transmitter command reading unit 22 reads a command mode set up by the transmitting apparatus 1 that is included in the received message. The transmitter command reading unit 22 determines whether the alert command mode or the no alert command mode is set up in the received message, and delivers the determination result to the receiving alert unit 23.

When the alert command mode is set up for the received message, the receiving alert unit 23 performs alert processing (e.g., alert processing that may disturb a receiver) so that the receiver may recognize that the message is received. For example, the receiving alert unit 23 informs the receiver that the message is received by a bell or a vibration that may be visually or acoustically recognized.

On the other hand, when the no alert command mode is set up for the received message, an alert operation is not performed. Particularly, when the no alert command mode is set up for the received message, even when a current operation mode of the receiving apparatus 2 is the receiving alert mode, the alert operation is not performed.

Further, when the no alert command mode is set up for the received message, the receiving alert unit 23 displays only a mark that informs that the message is received on a screen of the receiving apparatus 2 without an acoustic alert such as a bell or a vibration, and may perform alert processing after the previously set up time. In addition, when the receiving alert allow time is additionally set up for the received message other than the no alert command mode, alert processing may be performed when the receiving alert allow time passes from the message receiving time.

In addition, the mode set-up unit 24 sets up an operation mode of the receiving apparatus 2, and may set up a receiving alert mode by a receiver.

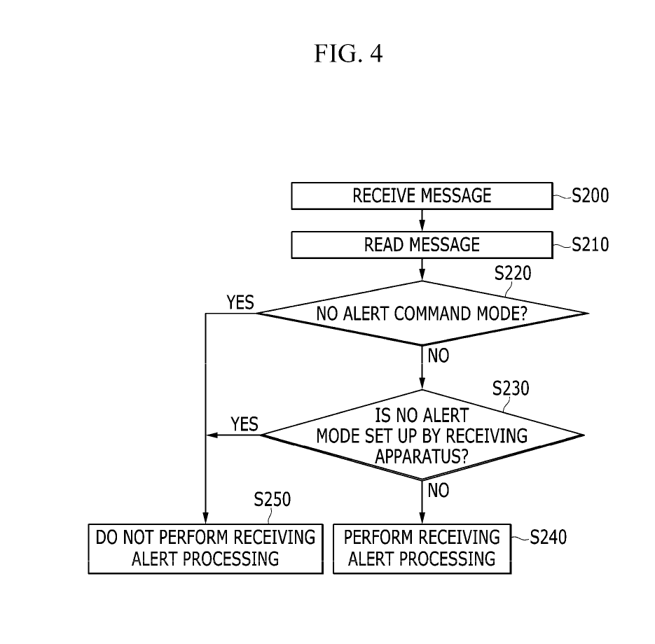

FIG. 4 is a flowchart of a message receiving method according to an exemplary embodiment of the present invention.

As illustrated in FIG. 4, the receiving apparatus 2 receives a message from the transmitting apparatus 1 (S200). Here, the receiving apparatus 2 accesses a network to receive a service.

The receiving apparatus 2 analyzes the received message to determine whether specific processing requested by the transmitting apparatus 1 is set up (S210). That is, the receiving apparatus 2 determines whether a code corresponding to the alert command mode or the no alert command mode is included in the received message.

When it is determined that the alert command mode is set up for the received message, the receiving apparatus 2 performs alert processing that informs that the message is received (S220). At this time, when a receiving no alert mode in which alert processing in the form of a bell or a vibration is not performed is set up since a receiver does not desire to receive a receiving alert, the receiving apparatus 2 may not perform the alert processing even if the alert command mode is set up for the received message.

For this purpose, when the alert command mode is set up for the received message, it is additionally determined whether a receiving no alert mode is set up by the mode set-up unit 24 of the receiving apparatus 2 (S230). The receiving apparatus 2 performs receiving alert processing in the alert command mode of the received message only when the receiving no alert mode is not set up (S240), and does not perform the receiving alert processing even if the alert command mode is set up for the received message when the receiving no alert mode is set up (S250).

On the other hand, when the no alert command mode is set up for the received message, the alert processing is not performed (S250). At this time, although the receiving alert mode in which it is informed that the message is received in the form of a vibration is set up by the mode set-up unit 24, when the no alert command mode is set up for the received message, the receiving apparatus 2 does not perform the alert processing.

On the other hand, when the receiving alert allow time is additionally set up for the received message other than the no alert command mode, the alert processing is performed when the receiving alert allow time passes from the message receiving time.

Through the above processes, when the receiver is sleeping or in a conference, although the receiver does not additionally perform set up, the receiver may not be disturbed by the receiving alert processing.

On the other hand, according to the exemplary embodiment of the present invention, a degree of order of priority (or a degree of disturbance) may be provided to the mode set up for the message by the transmitting apparatus 1 and the mode set up for the message by the receiving apparatus 2, and the receiving apparatus 2 compares the degree of order of priority of the mode set up for the received message with that of the mode set up thereby so that the alert processing may or may not be performed in a mode having a higher or lower degree of order of priority.

According to the exemplary embodiment of the present invention, when transmitting an instant message it is possible to easily set whether the received message alert operation at the receiver is performed. Therefore, the transmitter may send a message with no emergency without disturbing the sleep or work of the receiver.

The exemplary embodiment of the present invention described above is not only realized by an apparatus and a method, but may be realized by a program that realizes a function corresponding to a structure of the exemplary embodiment of the present invention or a recording medium in which the program is recorded. Such a realization may be easily realized by those skilled in the art by the above-described exemplary embodiment.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of a transmitting apparatus transmitting an instant message, the method comprising:
generating a message;
for the message, setting up an alert command mode in which it is instructed to perform alert processing when a receiving apparatus receives the message or a no alert command mode in which it is instructed not to perform the alert processing when the receiving apparatus receives the message; and
transmitting the message for which the alert command mode or the no alert command mode is set up.

2. The method of claim 1, wherein
setting up the alert command mode or the no alert command mode comprises:
setting up the no alert command mode for the message when a previously set up character stream is included in the generated message.

3. The method of claim 1, wherein
in setting up the alert command mode or the no alert command mode,
the alert command mode or the no alert command mode is set up in accordance with an operation of a toggle button provided in the transmitting apparatus.

4. The method of claim 1, further comprising
additionally setting up a receiving alert allow time that represents that the alert processing is performed after a set up time from a time when the receiving apparatus receives the message when the no alert command mode is set up for the message.

5. The method of claim 1, wherein the alert processing represents that receiving of the message is acoustically informed in a form of a bell or a vibration.

6. A message transmitting apparatus, comprising:
a message generator for generating a message;
a receiver processing set-up unit for setting up an alert command mode in which it is instructed to perform alert processing when a receiving apparatus receives a message or a no alert command mode in which it is instructed not to perform the alert processing when the receiving apparatus receives the message for the message; and
a message transmitting unit for transmitting the message for which the alert command mode or the no alert command mode is set up.

7. The message transmitting apparatus of claim 6, wherein the receiver processing set-up unit sets up a no alert command mode for the message when a previously set up character stream is included in the generated message.

8. The message transmitting apparatus of claim 6, further comprising
a state information managing unit for receiving state information that represents a network access state of a receiving apparatus from a server of a network to manage the received state information for an instant message service,
wherein the message transmitting unit transmits the message to the receiving apparatus that accesses the network based on the state information.

9. A method of a receiving apparatus receiving an instant message, the method comprising:
receiving a message;
determining whether an alert command mode or a no alert command mode set up by a transmitting apparatus is set up for the received message;
performing alert processing that informs that the message is received when the alert command mode is set up for the received message; and
not performing the alert processing that informs that the message is received when the no alert command mode is set up for the received message.

10. The method of claim 9, wherein
in not performing the alert processing,
when the no alert command mode is set up for the received message, although an operation mode of the receiving apparatus is set up as a receiving alert mode, the alert processing is not performed.

11. The method of claim 9, further comprising
after not performing the alert processing,
in a case where the no alert command mode is set up for the message and a receiving alert allow time is additionally set up for the message, when the receiving alert allow time passes from a time when the message is received, performing the alert processing.

12. The method of claim 9, wherein
performing the alert processing comprises:
determining whether a receiving no alert mode is set up by the receiving apparatus;
when the receiving no alert mode is set up, not performing the alert processing regardless of an alert command mode set up for the received message; and
when the received no alert mode is not set up, performing the alert processing in the alert command mode set up for the received message.

13. A message receiving apparatus, comprising:
a message receiving unit for receiving a message;
a transmitter command reading unit for determining whether an alert command mode or a no alert command mode set up by a transmitting apparatus is set up for a received message; and
a receiving alert unit for performing alert processing that informs that the message is received when the alert command mode is set up for the received message and not performing the alert processing that informs that the message is received when the no alert command mode is set up for the received message.

14. The message receiving apparatus of claim 13, wherein when the no alert command mode is set up for the message and a receiving alert allow time is additionally set up for the message, the receiving alert unit performs the alert processing when the receiving alert allow time passes from a time when the message is received.

15. The message receiving apparatus of claim 13, wherein the receiving alert unit compares a degree of order of priority provided to a mode set up for the received message with that provided to a mode set up by the receiving apparatus, and selectively performs the alert processing in the mode set up for the received message or the mode set up by the receiving apparatus in accordance with the comparison result.
